(19) United States
(12) Patent Application Publication
(10) Pub. No.: US 2017/0164144 A1
(43) Pub. Date: Jun. 8, 2017

(54) METHOD AND SYSTEM FOR SHARING LOCATION INFORMATION DURING VOICE CALL OVER NON-CELLULAR TECHNOLOGY

(71) Applicant: Samsung Electronics Co., Ltd, Gyeonggi-do (KR)

(72) Inventors: Akhil Madan Panchabhai, Bangalore (IN); Manish Dass, Bangalore (IN); Venkatesh Gowni Ramakrishna, Bangalore (IN); Vijay Saha, Bangalore (IN); Ravikumar Kalaimani, Bangalore (IN)

(21) Appl. No.: 15/368,544

(22) Filed: Dec. 2, 2016

(30) Foreign Application Priority Data
Dec. 4, 2015 (IN) 6511/CHE/2015

(51) Int. Cl. H04W 4/02; H04L 29/06

(52) U.S. Cl. CPC H04W 4/02; H04L 65/1006; H04W 84/12

(57) ABSTRACT

Embodiments herein provide a method for sharing information of location of a communication device during a voice call over the non-cellular technology. The method includes acquiring cellular location information directly or indirectly from a cellular network during the voice call. Further, the method includes sending the cellular network parameters in a Session Initiation Protocol (SIP) header field to a core network. The SIP P-header can be P-Alternate-Access-Network-Info. The cellular network parameters correspond to location related information of the communication device. The proposed method provides the location information of the communication device without relying on GPS information.

### CROSS-REFERENCE TO RELATED APPLICATION(S) AND CLAIM OF PRIORITY

The present application is related to and claims priority from Indian Application Number 6511/CHE/2015 filed on Dec. 4, 2015 and Indian Application No. 6511/CHE/2015 filed on Oct. 12, 2016, the disclosures of which are hereby incorporated by reference herein.

### TECHNICAL FIELD

The present disclosure relates to a communication system, and more particularly to a method for sharing location information of a communication device during a Voice call over a non-cellular technology.

### BACKGROUND

It is understood that in certain situations such as roaming or poor radio conditions, a communication device may not be able to obtain full service on a cellular domain. The communication device could be in a limited service and as such the home operator would not be able to determine an exact location of a user of the communication device. But, the user can still be connected to an internet through a wireless local area network (WLAN)/wireless fidelity (Wi-Fi) and can make a VoWi-Fi call through the Wi-Fi. In such cases, the WLAN media access control identification (MAC-ID) or Wi-Fi service set identifier (SSIDs) is shared to a network which may be unreliable for determining the user's location. Additionally, sharing global positioning system (GPS) information could be time and battery consuming as GPS signals can have large time to fix first (TTFF). Also, the GPS signals may be weak/not available especially in indoor locations and the Wi-Fi is common in an indoor environment.

Additionally, in home network long term evolution (LTE) coverage, for the VoWi-Fi registration scenario (LTE to Wi-Fi Handover), the location information is associated with a LTE home subscriber server (HSS)/location retrieval function (LRF). But this reliable location information may not be available with an IP multimedia subsystem (IMS) server because IMS sever is reliant on WLAN MAC ID contained in a SIP P-Access-Network-Info header for location information.

The above information is presented as background information only to help the reader to understand the present disclosure. Applicants have made no determination and make no assertion as to whether any of the above might be applicable as Prior Art with regard to the present application.

### SUMMARY

To address the above-discussed deficiencies, it is a primary object to provide a method for sharing information of location of a communication device during a voice call over a non-cellular technology.

Another object of the embodiments herein is to provide a method for sharing the location information of the communication device during a VoWi-Fi call.

Another object of the embodiments herein is to provide a method for sharing the location information of the communication device during the VoWi-Fi call over an IMS.

Another object of the embodiments herein is to provide a method for sharing information of location of the communication device during the VoWi-Fi call, when the communication device is in an airplane mode.

Another object of the embodiments herein is to provide a method for sharing information of location of the communication device during the VoWi-Fi call, when the communication device is in a cellular limited service.

Another object of the embodiments herein is to provide a method for sharing information of location of the communication device during the VoWi-Fi call, when the communication device is in a roaming network.

Another object of the embodiments herein is to provide a method for sharing information of location of the communication device during the VoWi-Fi call, when the communication device is in a no service area.

Another object of the embodiments herein is to provide a method for sharing information of location of the communication device during an emergency VoWi-Fi call.

Another object of the embodiments herein is to provide a method for sharing information of location of the communication device during the VoWi-Fi call for non-emergency VoWi-Fi calls.

Another object of the embodiments herein is to provide a method for acquiring cellular network parameters from signaling messages received from a cellular network during the VoWi-Fi call.

Another object of the embodiments herein is to provide a method for sending the cellular network parameters in a session initiation protocol (SIP) header field to a core network. The header can be sent in any SIP request or response messages.

Another object of the embodiments herein is to provide a method for mapping the cellular network parameters with the location related information to identify the location information of the communication device.

Accordingly the embodiments herein provide a method for sharing location information of a communication device during a voice call over a non-cellular technology. The method includes acquiring cellular network information from at least one signaling message received from a network entity during the voice call. Further, the method includes transmitting the cellular network information in a SIP header field to another network entity. The cellular network parameters correspond to location related information of the communication device.

In an embodiment, the SIP header field is a P-Access-Network-Info header field. The header can be included in any SIP request or response message. In an embodiment, the signaling messages are master informationbBlock (MIB). In an embodiment, the signaling messages are system information block (SIB). In an embodiment, the signaling messages can be a device to device (D2D) message.

In an embodiment, the cellular network parameters include a mobile country code (MCC), mobile network code (MNC), public land mobile network identifier (PLMN ID), code division multiple access (CDMA) system identifier/network identifier (SID/NID), location area code (LAC), routing area code (RAC), tracking area code (TAC), cell group identifier (CGI), cell ID (e.g., system information block3 (SIB3)-UMTS, SI3/4-GSM, SIB1-LTE)), frequency related information such as absolute radio frequency channel number (ARFCN), UTRA ARFCN (UARFCN), E-UTRA ARFCN (EARFCN), other cellular information pertaining to device location, such as, received signal strength indicator (RSSI), timing advance of a serving cell or neighbor cells associated with the cellular network, or the combination of all.

Accordingly the embodiments herein provide a system for sharing location information during a voice call over a non-cellular technology. The system includes a communication device, a core network entity and a cellular network entity. The communication device is configured to acquire cellular network parameters from signaling messages received from the cellular network entity. The communication device is configured to send the cellular network parameters in a SIP header field to the core network entity. The cellular network parameters correspond to location related information of the communication device. The core network is configured to map the cellular network parameters with the location related information to identify the location information of the communication device.

Accordingly the embodiments herein provide a method, by a network entity, for sharing location information of a communication device during a voice call over a non-cellular technology. The method includes receiving cellular network information in a session initiation protocol (SIP) header field from a communication device and identifying the cellular network information. Wherein the cellular network information is acquired from at least one signaling message received from another network entity during a voice call over a non-cellular technology.

Accordingly the embodiments herein provide a communication device. The communication device is configured to acquire cellular network information from at least one signaling message received from a network entity during a voice call over a non-cellular technology. The communication device is further configured to control to transmit the cellular network parameters in a SIP header field to another network entity. The cellular network parameters correspond to location related information of the communication device.

Accordingly the embodiments herein provide a network entity. The network entity is configured to control to receive cellular network information in a session initiation protocol (SIP) header field from a communication device. The network entity is further configured to identify the cellular network information.

Embodiment herein provides a computer program product including a computer executable program code recorded on a computer readable non-transitory storage medium. The computer executable program code when executed causing the actions including acquiring cellular network parameters from signaling messages received from a cellular network during a voice call over a non-cellular technology. The computer executable program code when executed causing the actions including sending the cellular network parameters in a SIP header field to a core network. The cellular network parameters correspond to location related information of the communication device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic of a system for sharing location information during a VoWi-Fi call, according to embodiments as disclosed herein;

FIG. 2 is a flow chart illustrating a method for sending a cellular network parameter included in a SIP header field to a core network, according to embodiments as disclosed herein;

FIG. 3 is a flow chart illustrating a method for sharing location information during the VoWi-Fi call, according to embodiments as disclosed herein;

FIG. 4 is a sequence diagram illustrating various steps in sharing location information during the VoWi-Fi call, when the communication device is in an airplane mode, according to embodiments as disclosed herein;

FIG. 5 is a sequence diagram illustrating various steps in sharing location information during the VoWi-Fi call, when the communication device is in a cellular limited service, according to embodiments as disclosed herein;

FIG. 6 is a sequence diagram illustrating various steps in sharing location information during the VoWi-Fi call, when the communication device is in a roaming network, according to embodiments as disclosed herein;

FIG. 7 is a sequence diagram illustrating various steps in sharing location information during the VoWi-Fi call, when the communication device is in a no service area, according to embodiments as disclosed herein; and

FIG. 8 shows various units of a communication device, according to embodiments as disclosed herein;

FIG. 9 shows various units of a core network entity, according to embodiments as disclosed herein;

FIG. 10 illustrates a computing environment implementing a mechanism for sharing location information during the VoWi-Fi call, according to embodiments as disclosed herein.

### DETAILED DESCRIPTION

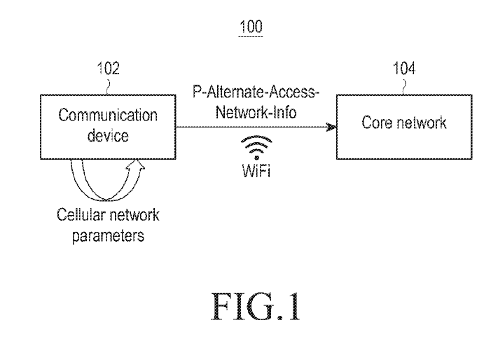

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Accordingly the embodiments herein achieve a method implemented in a communication device. The method includes acquiring cellular network parameters from signaling messages received from a cellular network during a voice call over a non-cellular technology. Further, the method includes sending the cellular network parameters in a SIP header field to a core network. The cellular network parameters correspond to location related information of the communication device.

The voice call over the non-cellular technology can be, for example but not limited to a VoWi-Fi call, a Voice over Internet Protocol (VoIP) call or the like.

Unlike the conventional methods and systems, the proposed method shares the location information of the communication device without relying on global positioning system (GPS) information. The method provides the location information of the communication device when the user of the communication device is not able to obtain full service in a roaming region while the communication device is in the core network e.g., Wi-Fi network. The proposed method provides an improved efficiency and accuracy of end-user location identification without being in the full service or limited service. The proposed method allows an introduction of new SIP header field (for example: P-Alternate-Access-Network-Info header field or P-Access-Network-Info header field) within the SIP header that carries additional information corresponding to the location from the cellular domain.

It is to be understood to a person of ordinary skilled in the art to name the new SIP P-header extension in another way according to RFC 7315 and is not limited to only P-Alternate-Access Network Info.

The proposed method facilitates sharing the location information of the communication device to a regulatory body (e.g., police department, military department, firefighting department or the like) in an efficient manner. This results in improving the security. By providing the location information of the communication device, the service to the user is enhanced.

The proposed method facilitates sharing the location information of the communication device to the regulatory body, when the user of the communication device does not have access to all the services in the cellular domain. The proposed method shares the location information of the communication device to the regulatory body, when the cellular registration/location is unknown to the home operator.

The proposed method facilitates sharing the location information of the communication device to the regulatory body, when the communication device is in full service area.

The proposed method facilitates sharing the location information of the communication device to the regulatory body, when the communication device is in No service area.

The proposed method can be used to share the information of location of the communication device during the VoWi-Fi call, when the user of the communication device is in emergency condition.

Referring now to the drawings and more particularly to FIGS. 1 through 10, where similar reference characters denote corresponding features consistently throughout the figures, there are shown preferred embodiments.

FIG. 1 is a schematic of a system 100 for sharing location information during the VoWi-Fi call, according to embodiments as disclosed herein. The system 100 includes a communication device 102 and a core network entity 104. The communication device 102 can be, for example but not limited to, a cellular phone, a tablet, a smart phone, a personal digital assistant (PDA), or any communication device. And the core network entity 104 can be, for example but not limited to, an entity supporting/managing an emergency call service, a content provider providing the emergency call service, a server managing a disaster in a core network or any network entity.

The communication device 102 is configured to acquire cellular network parameters from signaling messages received from the cellular network (not shown). In an embodiment, the cellular network parameters include MCC, MNC, PLMN ID (From MIB, SIB1), CDMA SID/NID, LAC, RAC, TAC, CGI, Cell ID (e.g., (SIB3-UMTS, SI3/4-GSM, SIB1-LTE)), frequency (ARFCN, UARFCN, EARFCN), other cellular information pertaining to device location, such as, RSSI, timing advance of a serving cell or neighbor cells associated with the cellular network, or combination thereof. And the cellular network parameters are included in cellular network information

In an embodiment, the signaling messages are master information block (MIB). In an embodiment, the signaling messages are system information block (SIB). In an embodiment, the signaling message is a device to device (D2D) message. It is to be understood to a person of ordinary skilled in the art that any other signaling message are used in the cellular communication is applicable. In an embodiment, the signaling messages are directly or indirectly read from the cellular network.

In an embodiment, the signaling messages are directly or indirectly read from the nearby devices using a short range communication.

After acquiring the cellular network parameters from the signaling messages, the communication device 102 is configured to send the cellular network parameters in a SIP header field to the core network entity 104. In an embodiment, the SIP header field is a P-Alternate-Access-Network-Info header field or a P-Access-Network-Info header field. The SIP header can be included in any SIP request or response message.

The SIP-P Header extension is as per RFC 7315, and may follow the same syntax as per section 5.4 which is applicable for existing SIP P-Access-Network-Info header and contain cellular information pertaining to the location.

In an embodiment, as per the 3GPP TS 24.229 V13.6.0 standard, a functional entity includes a Cellular-Network-Info header field in a request forwarded to another entity within the trust domain (i.e., cellular domain). Further, the Cellular-Network-Info field is applicable within the trust domain. The Cellular-Network-Info header field can be included in any SIP requests and responses in which the P-Access-Network-Info header field is present.

Usage of the Cellular-Network-Info header field. The Cellular-Network-Info header field is populated with the following contents:

1) the access-type field is set to one of “3GPP-GERAN”,“3GPP-UTRAN-FDD”, “3GPP-UTRAN-TDD”, “3GPP-E-UTRAN-FDD”, “3GPP-E-UTRAN-TDD”, “3GPP-E-UTRAN-ProSe-UNR”, “3GPP2-1X”, “3GPP2-1X-HRPD”, “3GPP2-UMB”, “3GPP2-1X-F emto” as appropriate to the additional access technology the information is provided about;

2) if the access-type field is set to “3GPP-GERAN”, a cgi-3gpp parameter set to the Cell Global Identity obtained from lower layers of the UE. The Cell Global Identity is a concatenation of MCC (3 decimal digits), MNC (2 or 3 decimal digits depending on MCC value), LAC (4 hexadecimal digits) and CI (as described in 3GPP TS 23.003 [3].The “cgi-3gpp” parameter is encoded in ASCII as defined in RFC 20 [212];

3) if the access-type field is equal to “3GPP-UTRAN-FDD”, or “3GPP-UTRAN-TDD”, a “utran-cell-id-3gpp” parameter set to a concatenation of the MCC (3 decimal digits), MNC (2 or 3 decimal digits depending on MCC value), LAC (4 hexadecimal digits) as described in 3GPP TS 23.003 [3]) and the UMTS Cell Identity (7 hexadecimal digits) as described in 3GPP TS 25.331 [9A]), obtained from lower layers of the UE. The “utran-cell-id-3gpp” parameter is encoded in ASCII as defined in RFC 20 [212];

4) if the access-type field is equal to “3GPP-E-UTRAN-FDD” or “3GPP-E-UTRAN-TDD”, a “utran-cell-id-3gpp” parameter set to a concatenation of the MCC (3 decimal digits), MNC (2 or 3 decimal digits depending on MCC value), Tracking Area Code (4 hexadecimal digits) as described in 3GPP TS 23.003 [3]) and the E-UTRAN Cell Identity (ECI) (7 hexadecimal digits) as described in 3GPP TS 23.003 [3]). The “utran-cell-id-3gpp” parameter is encoded in ASCII as defined in RFC 20 [212];

In an example, if the MCC is 111, the MNC is 22, the TAC is 33C4 and the ECI is 76B4321, then the Cellular-Network-Info header field looks like follows: Cellular-Network-Info: 3GPP-E-UTRAN-FDD;utran-cell-id-3gpp=1112233C476B4321

The cellular network parameters correspond to location related information of the communication device 102. The core network entity 104 is configured to map the cellular network parameters with the location related information to identify the location information of the communication device 102.

In an embodiment, the system 100 includes a home operator (not shown) to maintain a database to map the cellular information to identify the actual geographical location details/position of the communication device 102.

In an embodiment, the system 100 is configured to interact with a roaming operator (not shown) to map the cellular information to detect the actual geographical location details/position of the communication device 102.

In an embodiment, the system 100 is configured to interact with a third party server (not shown) to map the cellular information to detect the actual geographical location details/position of the communication device 102.

In an embodiment, the communication device 102 is configured to maintain a database or a storage unit (not shown) to map the cellular information to detect the actual geographical location details/position.

In an embodiment, the proposed method can be used to passively switch on a cellular radio for a short time to listen to the system information to collect relevant location information and embed in the SIP header.

The FIG. 1 shows the limited overview of the system 100 but, it is to be understood that other embodiments are not limited thereto. Further, the system 100 can include any number of hardware or software components communicating with each other. For example, the component can be, but not limited to, a process running in the controller or processor, an object, an executable process, a thread of execution, a program, or a computer.

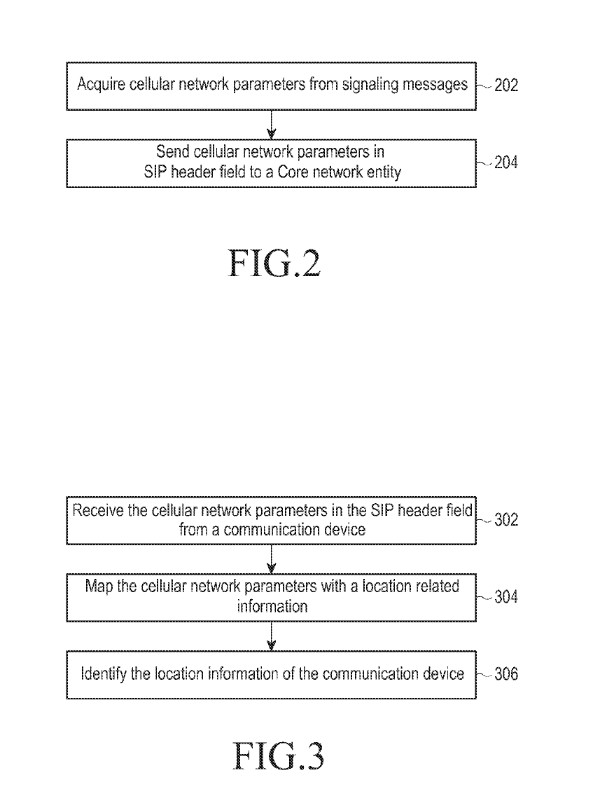

FIG. 2 is a flow chart illustrating a method for sending the cellular network parameter in the SIP header field to the core network entity 104, according to embodiments as disclosed herein. The steps (202 and 204) are performed by a processor (e.g. microprocessor, microcontroller or the like) comprised in the communication device 102. At step 202, the method includes acquiring the cellular network parameters from the signaling messages received from the cellular network during the VoWi-Fi call. In an embodiment, the method allows the communication device 102 to acquire the cellular network parameters from the signaling messages received from the cellular network during the VoWi-Fi call. At step 204, the method includes sending the cellular network parameters in the SIP header field to the core network entity 104. In an embodiment, the method allows the communication device 102 to send the cellular network parameters in the SIP header field to the core network entity 104.

The various actions, acts, blocks, steps, and the like in the method may be performed in the order presented, in a different order or simultaneously. Further, in some embodiments, some actions, acts, blocks, steps, and the like may be omitted, added, modified, skipped, and the like without departing from the scope of the present disclosure.

FIG. 3 is a flow chart illustrating a method for sharing location information during the VoWi-Fi call, according to embodiments as disclosed herein. The steps (302 to 306) are performed by a processor (e.g. microprocessor, microcontroller or the like) comprised in the core network entity 104. At step 302, the method includes receiving the cellular network parameters in the SIP header field from the communication device 102. At step 304, the method includes mapping the cellular network parameters with the location related information. At step 306, the method includes identifying the location information of the communication device 102.

The various actions, acts, blocks, steps, and the like in the method may be performed in the order presented, in a different order or simultaneously. Further, in some embodiments, some actions, acts, blocks, steps, and the like may be omitted, added, modified, skipped, and the like without departing from the scope of the present disclosure.

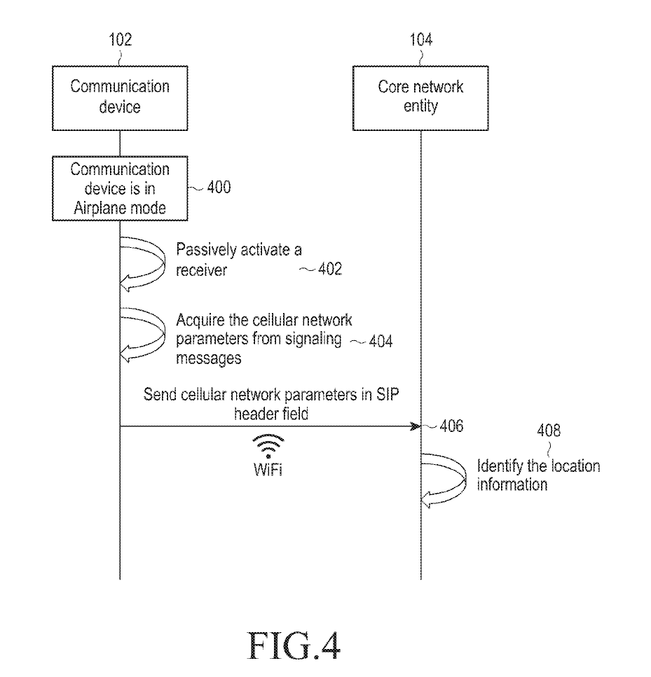

FIG. 4 is a sequence diagram illustrating various steps in sharing location information during the VoWi-Fi call, when the communication device 102 is in the airplane mode (400), according to embodiments as disclosed herein. The communication device 102 itself passively activates (402) a receiver (not shown). The proposed method can be used to passively switch ON the receiver for a short time to listen to the system information to collect relevant location information and embed in the SIP header.

The communication device 102 acquires (404) the cellular network parameters from the signaling messages. The communication device 102 sends (406) the cellular network parameters in the SIP header field to the core network entity 104. The core network entity 104 identifies (408) the location information by mapping the cellular network parameters with the location related information.

The proposed method allows enablement the receiver to decode/measure broadcast information for location detail even when the airplane mode is ON. As a result there are no interference/violations with the transmitter being OFF in the airplane ON mode.

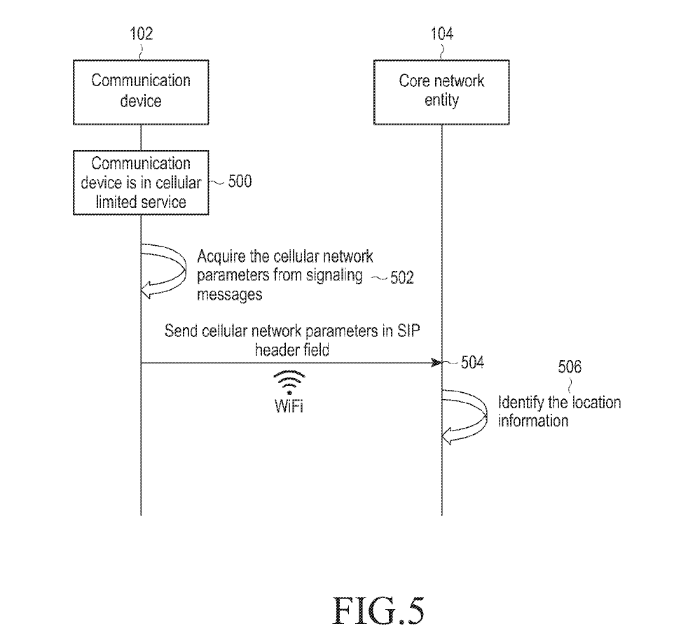

FIG. 5 is a sequence diagram illustrating various steps in sharing location information during the VoWi-Fi call, when the communication device 102 is in the cellular limited service, according to the communication device 102 is in the cellular limited service, according to embodiments as disclosed herein. The communication device 102 acquires (502) the cellular network parameters from the signaling messages. The communication device 102 sends (504) the cellular network parameters in the SIP header field to the core network entity 104. The core network entity 104 identifies (506) the location information by mapping the cellular network parameters with the location related information.

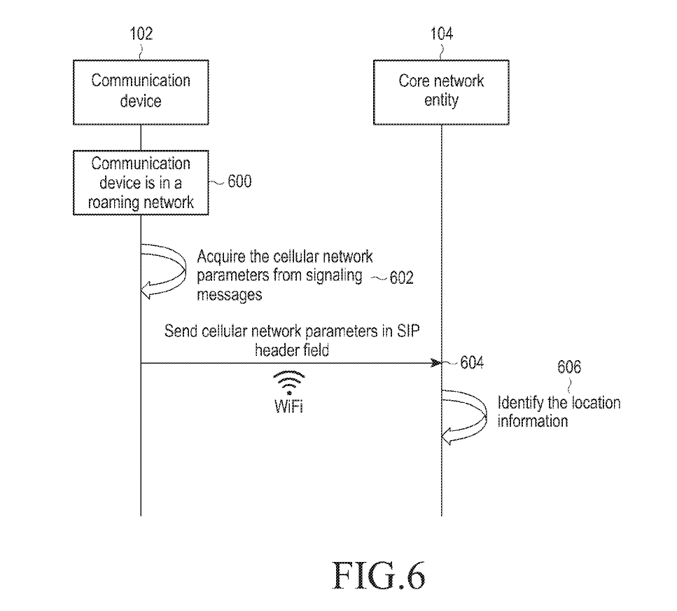

FIG. 6 is a sequence diagram illustrating various steps in sharing location information during the VoWi-Fi call, when the communication device 102 is in the roaming network (600), according to embodiments as disclosed herein. The communication device 102 acquires (602) the cellular network parameters from the signaling messages. The communication device 102 sends (604) the cellular network parameters in the SIP header field to the core network entity 104. The core network entity 104 identifies (606) the location information by mapping the cellular network parameters with the location related information.

The proposed method allows the home operator to maintain the database to map the cellular information of roaming operator to identify the actual geographical location details/position of the communication device 102.

The proposed method allows the home operator to interact with the roaming operator for mapping the cellular information of the roaming operator to detect the actual geographical location details/position of the communication device 102.

The proposed method allows the home operator to interact with the third party server to map the cellular information of the roaming operator to find the actual geographical location details/position of the communication device 102.

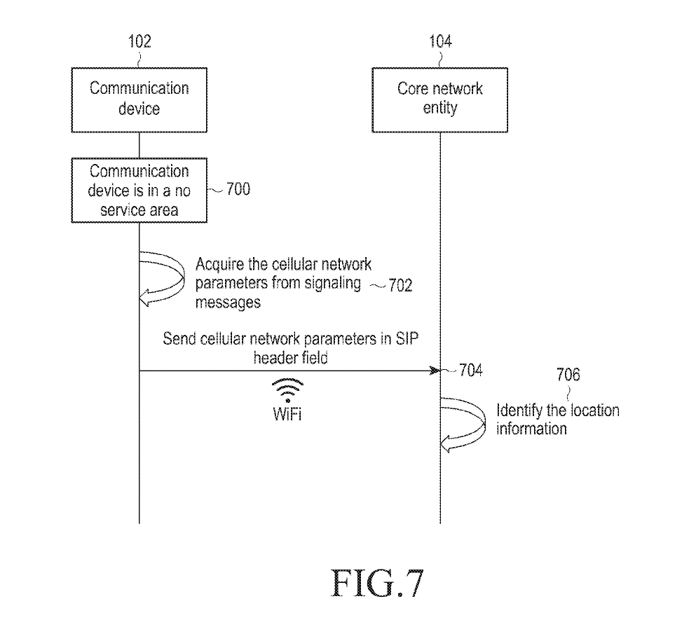

FIG. 7 is a sequence diagram illustrating various steps in sharing location information during the VoWi-Fi call, when the communication device 102 is in the no service area (700), according to embodiments as disclosed herein. The communication device 102 can discover other nearby devices using other technologies such as ProSe (e.g., Device-to-Device (D2D)), the WiFi, or the like. The nearby devices are in full or limited cellular coverage area. The communication device 102 acquires (702) the cellular network parameters from the signaling messages. In an embodiment, the cellular network parameters include MCC, MNC, PLMN ID (From MIB, SIB1), CDMA SID/NID, LAC, RAC, TAC, CGI, Cell ID (e.g., (SIB3-UMTS, SI3/4-GSM, SIB1-LTE)), frequency (ARFCN, UARFCN, EARFCN), other cellular information pertaining to device location, such as, RSSI, timing advance of a serving cell or neighbor cells associated with the cellular network, or any combination thereof.

The communication device 102 sends (704) the cellular network parameters in the SIP header field to the core network entity 104. The core network entity 104 identifies (706) the location information by mapping the cellular network parameters with the location related information.

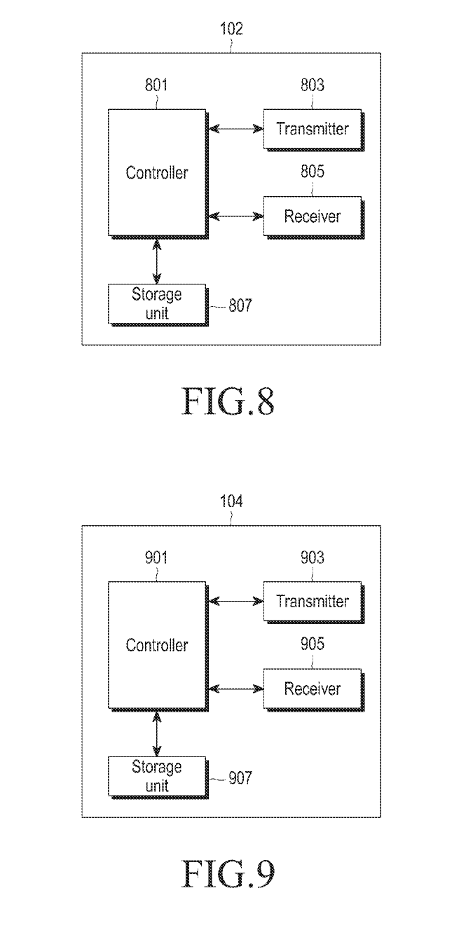

FIG. 8 shows various units of the communication device 102, according to embodiments as disclosed herein.

Referring to FIG. 8, the communication device 102 includes a controller 801, a transmitter 803, a receiver 805 and a storage unit 807.

The controller 801 controls the overall operation of the communication device 102, particularly, operations related to a location information sharing operation according to an embodiment of the present disclosure. The operations related to the channel sensing operation according to an embodiment of the present disclosure are the same as those described above in connection with FIGS. 1 to 7, and no detailed description thereof is repeated.

The transmitter 803 transmits various signals and messages to other entities included in the communication system under the control of the controller 801. Here, the signals and messages transmitted by the transmitter 803 are the same as those described above in connection with FIGS. 1 to 7, and no detailed description thereof is repeated.

The receiver 805 receives various signals and messages from other entities included in the communication system under the control of the controller 801. Here, the signals and messages received by the receiver 805 are the same as those described above in connection with FIGS. 1 to 7, and no detailed description thereof is repeated.

The storage unit 807 stores programs and various data related to operations for performing the location information sharing operation by the communication device 102 under the control of the controller 801 according to an embodiment of the present disclosure. The storage unit 807 stores various signals and messages received by the receiver 805 from other entities.

Although FIG. 8 illustrates that the communication device 102 includes separate units, such as the controller 801, the transmitter 803, the receiver 805, and the storage unit 807, the communication device 102 may be implemented in such a manner that at least two of the controller 801, the transmitter 803, the receiver 805, and the storage unit 807 are integrated together. Further, the communication device 102 may be implemented in a single processor.

FIG. 9 shows various units of the core network entity 104, according to embodiments as disclosed herein.

Referring to FIG. 9, the core network entity 104 includes a controller 901, a transmitter 903, a receiver 905 and a storage unit 907.

The controller 901 controls the overall operation of the core network entity 104, particularly, operations related to a location information sharing operation according to an embodiment of the present disclosure. The operations related to the channel sensing operation according to an embodiment of the present disclosure are the same as those described above in connection with FIGS. 1 to 7, and no detailed description thereof is repeated.

The transmitter 903 transmits various signals and messages to other entities included in the communication system under the control of the controller 901. Here, the signals and messages transmitted by the transmitter 903 are the same as those described above in connection with FIGS. 1 to 7, and no detailed description thereof is repeated.

The receiver 905 receives various signals and messages from other entities included in the communication system under the control of the controller 901. Here, the signals and messages received by the receiver 905 are the same as those described above in connection with FIGS. 1 to 7, and no detailed description thereof is repeated.

The storage unit 907 stores programs and various data related to operations for performing the location information sharing operation by the core network entity 104 under the control of the controller 901 according to an embodiment of the present disclosure. The storage unit 907 stores various signals and messages received by the receiver 905 from other entities.

Although FIG. 9 illustrates that the core network entity 104 includes separate units, such as the controller 901, the transmitter 903, the receiver 905, and the storage unit 907, the core network entity 104 may be implemented in such a manner that at least two of the controller 901, the transmitter 903, the receiver 905, and the storage unit 907 are integrated together. Further, the core network entity 104 may be implemented in a single processor.

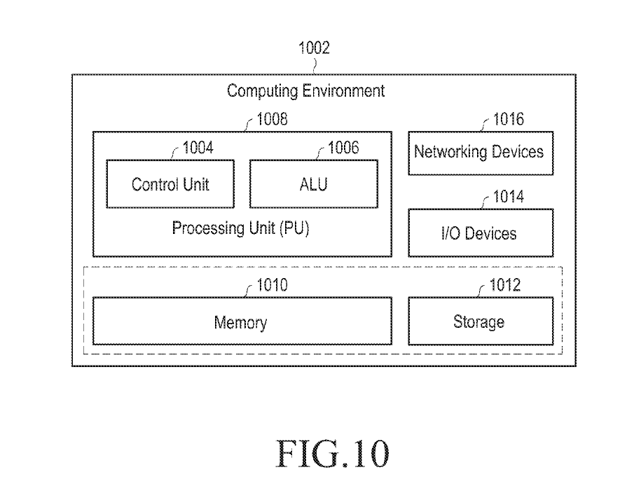

FIG. 10 illustrates the computing environment 1002 implementing a mechanism for sharing location information during the VoWi-Fi call, according to embodiments as disclosed herein. The computing environment 1002 comprises at least one processing unit 1008 that is equipped with a control unit 1004, an Arithmetic Logic Unit (ALU) 1006, a memory 1010, a storage unit 1012, a plurality of networking devices 1016 and a plurality Input/Output (I/O) devices 1014. The processing unit 1008 is responsible for processing the instructions of the technique. The processing unit 1008 receives commands from the control unit 1004 in order to perform processing. Further, any logical and arithmetic operations involved in the execution of the instructions are computed with the help of the ALU 1006.

The overall computing environment 1002 can be composed of multiple homogeneous or heterogeneous cores, multiple CPUs of different kinds, special media and other accelerators. The processing unit 908 is responsible for processing the instructions of the technique. Further, the plurality of processing units 1004 may be located on a single chip or over multiple chips.

The technique comprising of instructions and codes required for the implementation are stored in either the memory unit 1010 or the storage 1012 or both. At the time of execution, the instructions may be fetched from the corresponding memory 1010 or storage 1012, and executed by the processing unit 1008.

In case of any hardware implementations various networking devices 1016 or external I/O devices 1014 may be connected to the computing environment 1002 to support the implementation through the networking unit and the I/O device unit.

The proposed method can also be applied to a Push-To-Talk (PTT), a Short Message Service (SMS) over IMS, a SIP based application and other Rich Communication Services (RCS) services signaling.

The embodiments disclosed herein can be implemented through at least one software program running on at least one hardware device and performing network management functions to control the elements. The elements shown in the FIGS. 1 through 10 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of operating a communication device, the method comprising:
acquiring cellular network information from at least one signaling message received from a network entity during a voice call over a non-cellular technology; and
transmitting the cellular network information in a session initiation protocol (SIP) header field to another network entity.

2. The method of claim 1, wherein the cellular network information corresponds to location related information of the communication device.

3. The method of claim 1, wherein the SIP header field is a P-Access-Network-Info header field.

4. The method of claim 1, wherein the at least one signaling message includes at least one of a master information block (MIB), a system information block (SIB), or a device to device (D2D) message.

5. The method of claim 1, wherein the cellular network information includes at least one of a mobile country code (MCC), a mobile network code (MNC), a public land mobile network identifier (PLMN ID), a code division multiple access (CDMA) system identifier/network identifier (SID/NID), a location area code (LAC), a region area code (RAC), tracking area code (TAC), cell group identifier (CGI), cell ID, frequency received signal strength indicator (RSSI), a timing advance of a serving cell associated with a cellular network, or a timing advance of a neighbor cell associated with the cellular network.

6. A method of operating a network entity, the method comprising:
receiving cellular network information in a session initiation protocol (SIP) header field from a communication device; and
identifying the cellular network information,
wherein the cellular network information is acquired from at least one signaling message received from another network entity during a voice call over a non-cellular technology.

7. The method of claim 6, wherein the cellular network information corresponds to location related information of the communication device.

8. The method of claim 6, wherein the SIP header field is a P-Access-Network-Info header field.

9. The method of claim 6, wherein the at least one signaling message includes at least one of a master information block (MIB), a system information block (SIB), or a device to device (D2D) message.

10. The method of claim 6, wherein the cellular network information includes at least one of a mobile country code (MCC), a mobile network code (MNC), a public land mobile network identifier (PLMN ID), a code division multiple access (CDMA) system identifier/network identifier (SID/NID), a location area code (LAC), a region area code (RAC), tracking area code (TAC), cell group identifier (CGI), cell ID, frequency received signal strength indicator (RSSI), a timing advance of a serving cell associated with a cellular network, or a timing advance of a neighbor cell associated with the cellular network.

11. A communication device comprising:
a transceiver configured to transmit and receive data; and
a controller configured to:
acquire cellular network information from at least one signaling message received from a network entity during a voice call over a non-cellular technology,
control to transmit the cellular network information in a session initiation protocol (SIP) header field to another network entity.

12. The communication device of claim 11, wherein the cellular network information corresponds to location related information of the communication device.

13. The communication device of claim 11, wherein the SIP header field is a P-Access-Network-Info header field.

14. The communication device of claim 11, wherein the at least one signaling message includes at least one of a master information block (MIB), a system information block (SIB), or a device to device (D2D) message.

15. The communication device of claim 11, wherein the cellular network information includes at least one of a mobile country code (MCC), a mobile network code (MNC), a public land mobile network identifier (PLMN ID), a code division multiple access (CDMA) system identifier/network identifier (SID/NID), a location area code (LAC), a region area code (RAC), tracking area code (TAC), cell group identifier (CGI), cell ID, frequency received signal strength indicator (RSSI), a timing advance of a serving cell associated with a cellular network, or a timing advance of a neighbor cell associated with the cellular network.

16. A network entity comprising:
a transceiver configured to transmit and receive data; and
a controller configured to:
control to receive cellular network information in a session initiation protocol (SIP) header field from a communication device, and
identify the cellular network information,
wherein the cellular network information is acquired from at least one signaling message received from another network entity during a voice call over a non-cellular technology.

17. The network entity of claim 16, wherein the cellular network information corresponds to location related information of the communication device.

18. The network entity of claim 16, wherein the SIP header field is a P-Access-Network-Info header field.

19. The network entity of claim 16, wherein the at least one signaling message includes at least one of a master information block (MIB), a system information block (SIB), or a device to device (D2D) message.

20. The network entity of claim 16, wherein the cellular network information includes at least one of a mobile country code (MCC), a mobile network code (MNC), a public land mobile network identifier (PLMN ID), a code division multiple access (CDMA) system identifier/network identifier (SID/NID), a location area code (LAC), a region area code (RAC), tracking area code (TAC), cell group identifier (CGI), cell ID, frequency received signal strength indicator (RSSI), a timing advance of a serving cell associated with a cellular network, or a timing advance of a neighbor cell associated with the cellular network.
